(19) United States
(12) Patent Application Publication
(10) Pub. No.: US 2012/0265650 A1
(43) Pub. Date: Oct. 18, 2012

(54) Diet and Nutrition Planning System based on health needs

(76) Inventor: Brad Raymond Gusich, Hermosa Beach, CA (US)

(21) Appl. No.: 13/086,399

(22) Filed: Apr. 14, 2011

(51) Int. Cl. G06F 3/048; G06Q 30/00

(52) U.S. Cl. 705/27.2; 715/810; 715/832

(57) ABSTRACT

A diet planning system is describes which assists a user to plan his/her diet plan according to the health needs. A user is provided to select a health status from a list of available health effects, a food group and food item list appear upon selection of the health status from which the user selects a plurality of food items. A food item rank calculator provides a priority score for the selected food item. The calculation basis of the priority score can be altered by user using a dial and accordingly make it depend totally upon the user's health needs or the overall nutrient content of the food item. The user is further provided an option to make a virtual plate, a smoothie or shop for the grocery online.

### FIELD OF THE INVENTION

The invention relates in general to the diet planning system and particularly to the nutrition planning based on the health needs of a user.

### BACKGROUND OF THE INVENTION

Nutrition Planning and management has historically been a specialized activity by dieticians and nutrition experts. It is advantageous to have a nutrition and diet plan according to the health status for an individual. Each individual has different health and metabolic needs and they have to be fulfilled by the daily diet and meals. The health-seeking individual has certain long- and short-term health and wellness desires that may be improved by certain nutrients. On the other hand, the deficiency of one or more nutritious elements may cause physical or mental diseases.

Personalized menus and plates have been previously created using various software tools. The U.S. Pat. No. 6,980,999 by Clare Grana describes a method of communicating dietary information to a user by storing dietary information in an information database. The method further inputs a user assessment for manipulated dietary information. The method described in the patent requires a user to input the assessment and does not assist the user with identifying foods within certain selected food categories. It also does not generate a priority score for each item in a selected food category that is based on the user's health needs.

The U.S. published application number 20100198699 by Dotson describes a nutrition system that provides a customized dietary plan for a user based on the user's profile. A nutritional questionnaire is filled by the user, and a metabolic profile calculated. A number of plate designs are provided to the user, from which one is selected. However, the patent does not assist the user with selecting from a full listing of foods ranked for the user's combination of physiological health needs or ailments. Further, the system does not provide referenced evidence correlating the plate contents to the metabolic profile.

Therefore, there is a need for a dietary planning tool which can identify food and beverages that will improve a desired physiological function or mitigate an ailment identified by the user. Further, there is a need for a management tool that will consider a combination of these health needs and provide the optimal food selections for the user to positively impact these health needs.

### SUMMARY OF THE INVENTION

A diet planning system for identifying diet needs of a person, comprising a health need selection tool for selecting and adding the health status from a set of health groups to a list, a food selection tool for choosing food items at varying degrees of food category specificity, prioritized according to the health status of the person, a rank calculator for calculating a rank for the food items selected based on the health status needs of the person, and a nutrient visualizer for graphically viewing the nutrients of the food items selected and the strength of the research that correlates the foods to the desired health needs wherein, the rank calculator calculates the rank of food items based on the health status needs, gender, age, mass of the user, as well as the strength of research supporting the nutrient-to-health-effect correlation.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts a user interface for selection of health group and health needs.

FIG. 2 depicts a user interface for selection of food groups and food items.

FIG. 3 depicts an embodiment of nutrient visualization graph.

FIG. 4 depicts an embodiment of the plate created by the user upon selection of food items.

FIG. 5 depicts a flowchart in accordance with the system workflow for selecting health status and food items.

FIG. 6 depicts a flowchart in accordance with the system workflow for selecting various options after the selection of food items.

### DETAILED DESCRIPTION OF THE PREFERRED EMBODIMENT

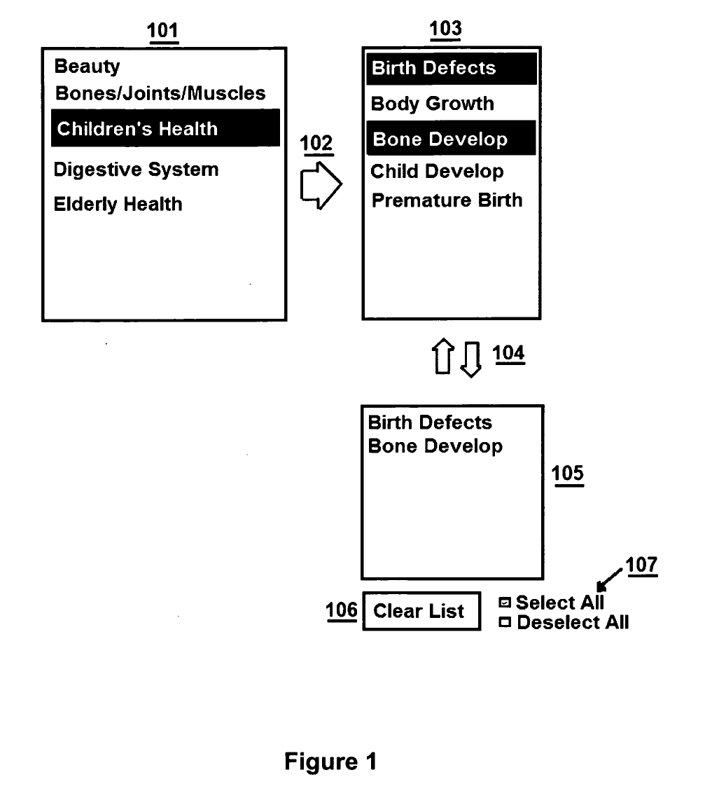

FIG. 1 describes an embodiment of the system graphical interface depicting the health group 101 and health effect 103 selection boxes. The health group selection box 101 comprises a plurality of health related issues grouped together in various headings, which are selectable by the user. After a heading is selected from the health group box 101, the selection appears in the health effect box 103. The health group box 101 and health selection box 103 can be implemented using a list box in HTML development environment. The selection flow of the health group to health effect boxes is depicted by the arrow 102. The health effect box 103 is a multi-item selectable box. A user can select a plurality of items from the box and send them to the ‘My health list’ box 105. The box 105 is a similar list box which contains the selected items from the box 103. Also, the items in my health list box 105 can be removed and sent back to the health effect list box 103 by clicking on the back arrow 104. In order to select or deselect the items in the list box 105, there are options 107 provided. The entire list of the list box 105 can be cleared by clicking the button 106. There are options provide to the user for saving the health list or continue without saving the health list. If a user chooses to save the health list, he/she can revisit personalized health list again and act upon the existing health lists, without creating a new one. This saves significant amount of time for users who have multiple and complex health needs. The described user interface arrangement provides a user with a flexibility to choose any number of heath effect items at one time and plan the diet needs for the chosen health status in the next section.

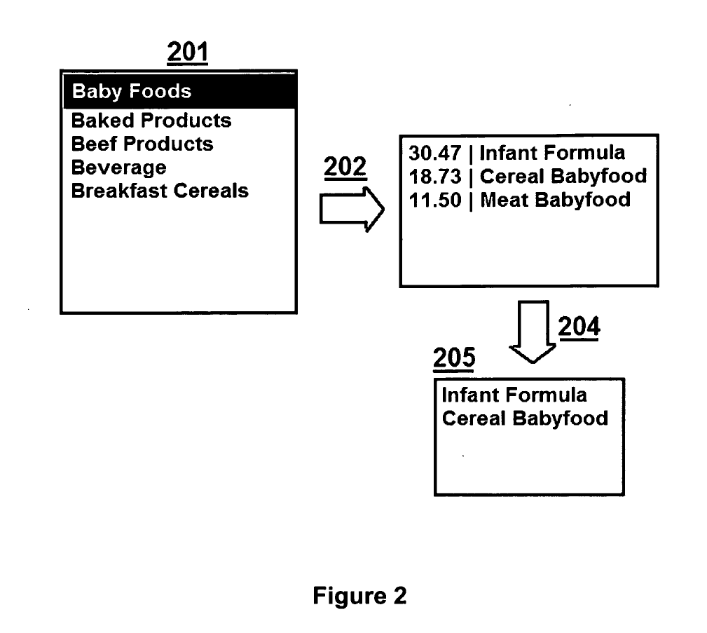

FIG. 2 describes the next section of the graphical interface of the system which comprises a food group box 201 containing various food groups. The food groups are according to the selected health status in the previous section by the user. After selection of the food group through 202, a plurality of food items are populated in the food list 203. The food list 203 comprises a priority score for the food item which is basically a rank associated with the food item. The priority score is based upon a complex formula which includes the overall nutrient content factor and health need factors as inputs. A user is also allowed to change the inputs to the priority score calculation function by adjusting the priority score dial. By default, the priority score is set at the average score for a food item. The food item list 203 is a multi-select box so that more than one food items can be selected by the user. The selected food items go to My Food list 205 through selection process 204. The food items selected in the My Food list 205 is used to prepare the plate or smoothie. Additionally, the food items can also be added to my grocery list and added to online shopping cart for ordering.

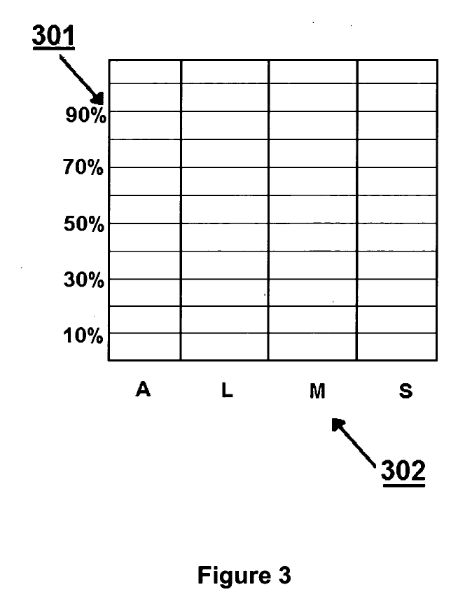

FIG. 3 shows an embodiment of the graphical representation of nutrient visualizer. The nutrient visualizer can be used for graphically viewing the nutrients of the food items selected. The results shown in the nutrient visualizer depend upon the strength of the research that correlates the foods to the desired health needs. The vertical axis 301 depicts the percentage daily recommended intake while the horizontal axis represents the strength of research correlating the health effect with the nutrients. In one of the embodiments, the research strength has been divided into four types that are Anecdotal, Limited, Moderate and Strong effect. The graph provides the percentage of various nutrients that are present in the selected food item and their strength. On a mouse hover or click on the graph provides further details on the effect of the nutrient on the health and its function. Each graph renders the nutrient data for one food item and one health effect; the graph can be altered by changing selections amongst the user's identified health effects by toggling the Health Effect combo above the graph.

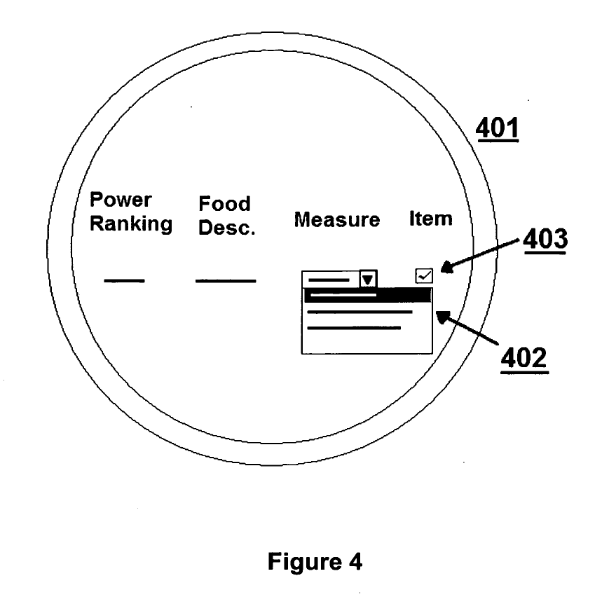

FIG. 4 shows an embodiment of the plate 401 created by the user. The plate 401 is created after a user selects the option of creating plate by selecting the food items of choice. The plate is a representative illustration of the food items along with their Priority ranking. A measurement option is provided which changes according to the food item selected. For example, if the food item selected is Wheat Pancake, then the option of measurement in cups appears; however when the food item selected is Waffle, the options for measurement include waffle size in square inch as well. The items appearing in the plate can be selected using 403 and corresponding nutrient information can be viewed in the table below.

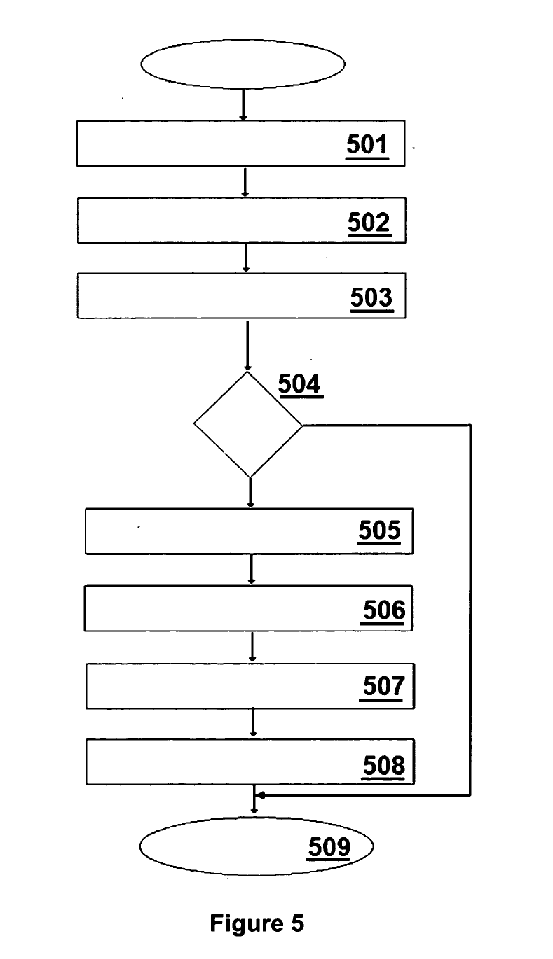

FIG. 5 describes a flowchart view of the process. The user starts the process 501 by selecting a health group from the list. The selecting of health effect 502 takes place next and the selected health effect is added to the ‘My health list’ in step 503. The user has options to select or de-select more than one health effect entries to my health list, depending upon the health need or desire. For example, an elderly user may have a need to look for the diet plan for heart problems. Such a user might select appropriate options from both ‘Elderly health’ as well as ‘Heart/Blood/Cardiovascular’ health groups. There is an option to select all the entries in My Health List by pressing Select All button. The list can also be instantly cleared by pressing Clear button. The user has an option to save the health list in step 504, which the user can refer to in future. In some of the cases, health lists could be very elaborative and represent complex medical situations. In order to save time to recreate the health list, the option of saving is provided. However, the user can still proceed using the tool without saving the list, as the health needs are stored temporarily on the site for just that user's user session. Next, the user will be prompted to the next page which is about selection of food groups and food items. A food group list is provided to the user to select a group of food items in step 505. Each food group contains a number of individual food items, which appear on selection of a food group. A plurality of food items are selected in step 507. Step 506 provides an option to choose the basis of calculating the rank of the food items, which is referred here as Priority Score. The bases of priority score calculation depend upon a number of factors. The priority score function primarily depends upon the value of overall nutrient content and the health needs of the user. The priority score can be changed using the dial, which basically toggles the score. When the dial is at the left extreme, the priority score depends solely upon the overall nutrient content of the food items, with no regard to the health needs. When the dial is at the extreme right, the priority score depends solely on the health needs of the user. By default, the priority score is set at an average value. Such a flexibility in priority score or food rank calculation is useful for people who want or do not want to take the benefit of the background research done on a food item with respect to a given health need. When a food item is selected, the corresponding graphical representation of nutrient visualizer appears as described earlier.

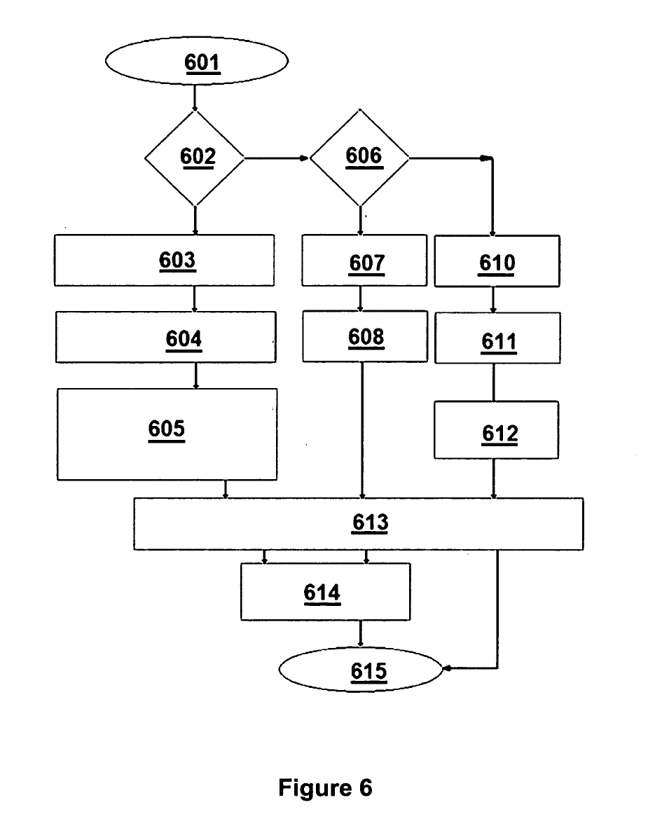

FIG. 6 represents a flowchart for steps which can be taken once a set of food items is selected and saved 601. A user can have various options including creating a plate 602, creating smoothie 606 and shopping for grocery 610. If a user selects to create a plate, he/she gets to know the nutrients related to the plate items in a list 605. This list is important to make the user aware of the nutrition information about the plate items. A user can also make a smoothie out of the food items at step 607. The process and algorithm of creating a smoothie at step 608 is complex and depends upon multiple factors. The user also has the option to share the plate or smoothie using email or text message in step 614 from within the system. This feature provides a way to popularize the diet planning system among other potential users.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A diet planning system for identifying diet needs of a person, comprising:
a health need selection tool for selecting and adding the health status from a set of health groups to a list;
a food selection tool for choosing food items at varying degrees of food category specificity for further prioritization using the rank calculator;
a rank calculator for calculating a rank for the selected food items; and
a nutrient visualizer for graphically viewing the nutrients of the food items selected and the strength of the research that correlates the foods to the desired health needs;
wherein, the rank calculator calculates the rank of food items based on the health status needs, gender, age, mass of the user, as well as the strength of research supporting the nutrient-to-health-effect correlation.

2. The health need selection tool according to claim 1, comprises a health group selection set and a health effect selection set.

3. The health need selection tool according to claim 1, further comprises a feature to create a personalized health list.

4. The health need selection tool according to claim 1, further comprises a feature to save the personalized health list.

5. The health need selection tool according to claim 1, further comprises a feature to create a plurality of plates with the food preference of the person.

6. The food selection tool according claim to 1, comprises a food group set.

7. The food selection tool according to claim 1, comprises a selectable list of food items linked to the food group set.

8. The selectable list according to claim 7, comprises a plurality of food items and rank of the each of the plurality of food items.

9. The rank customizer according to claim 8, varies the rank of the selected food item based on overall nutrient content of the food item and the health status.

10. The nutrient visualizer according to claim 1, displays the nutrient associated with the selected food item based on daily percentage recommended intake.

11. The diet planning system according to claim 1, further comprises a dial for adjusting the rank of the food item.

12. The dial according to claim 11 toggles the rank of the food item on a continuous range, from based solely on the nutrition content of the food items with no regard to the user's health needs to based on solely the health needs the user identified according to claim 4 with no regard to the overall nutrient content of the food item.

13. The diet planning system according to claim 1 further comprises an ordering tool for online shopping of the food items.

14. A method of managing the food preference of a person, the method comprising:
Selecting health status from a set of health groups;
Selecting food items from a list of food items;
Calculating a rank for the selected food item based on the health status of the person;
Adjusting the rank of the selected food item using a dial; and
Graphically visualizing the nutrients of the food items selected.
